(19) United States
(12) Patent Application Publication
(10) Pub. No.: US 2020/0016861 A1
(43) Pub. Date: Jan. 16, 2020

(54) A CORNET BENDING MACHINE WITH INDEPENDENT MOTION CONTROL SYSTEM FROM MECHANICS

(71) Applicant: MONDI AG, Kirklareli (TR)

(72) Inventors: Umit SAHIN, Kirklareli (TR); Osman KADIROGLU, Kirklareli (TR)

(21) Appl. No.: 16/494,475

(22) PCT Filed: Nov. 8, 2017
(86) PCT No.: PCT/TR2017/050556

§ 371 Date: Sep. 16, 2019

(30) Foreign Application Priority Data
Jun. 6, 2017 (TR) 201708349

(51) Int. Cl. B31F 7/02; B31B 50/34; B31B 70/26; B31F 7/00

(52) U.S. Cl. CPC B31F 7/02; B31B 50/34; B31B 2110/10; B31F 7/004; B31B 70/30

(57) ABSTRACT

A high-speed cornet bending machine with high production capacity and mechanically independent motion control system is provided. At least one feeding device is provided for transferring the sheets in order to the conveying device. Feeding device motors are provided for driving the feeding device. Conveying devices include a transfer line for transferring the sheets from the transport apparatus to the end bending unit as standard and end bending units for standard bending the product ends into a high production capacity and mechanically independent movement control system.

### TECHNICAL FIELD

The invention relates to a high-speed cornet bending machine with high production capacity and mechanically independent motion control system.

### KNOWN STATUS OF TECHNIQUE

Cornet bending machines known in the art generally operate mechanically. The motion control systems of these machines are mechanically designed. Since these machines are operated entirely with gears and transmission systems, mechanical failures frequently occur. Another drawback of conventional cornet bending machines is that they have very low manufacturing speeds. For this reason, labor costs are quite high.

In the patent search of the prior art, a useful model with reference number 2015/12633 of classification class B31F 7/00 was found. This application is concerned with novelty in paper folding apparatus which is developed in order to make paper insertion and curling process easier in paper folding art (Quilling) and advantageous because of its short end and long end curvature and its risk free structure especially suitable for children's use.

Another application of the prior art is the utility model 2006/01473 of class A 24 C 5/47, A crimping device for a filter accessory includes at least one blade-like member that contacts the material in a specific contact area so as to deform a continuous strip of paper material as it travels so that the crimping unit of the accessory imparts a crimped profile to the single end wrapping paper separated from the strip And as a result, when combined they wrap and combine the combined filter and cigarette rods more easily; The curling device further comprises a delivery system for delivering a cushioning fluid to the contact area designed to provide a smooth sliding contact between the crimping element and the advancing strip and also to equalize the tension of the strip in front of and in the region following the contact area.

As a result, there is a need to develop new high-speed cornet bending machines with high production capacity and mechanically independent motion control systems, which will overcome the disadvantages mentioned above and solve the existing systems.

### PURPOSE OF THE INVENTION

The present invention relates to a high-speed cornet bending machine with high production capacity and mechanically independent motion control system.

The primary object of the invention is; To increase production speeds.

One aim of the invention is to reduce maintenance costs.

Another object of the invention is to reduce unit labor costs.

One object of the invention is to prevent mechanical failures.

Another object of the invention is prevention of work accidents.

One of the objects of the invention is to provide a business change advantage in a short time.

### FIGURES TO HELP THE COMPREHENSION OF INVENTION

FIG. 1 is a perspective view showing the inventive cornfolder.

FIG. 2 is a perspective view showing the tip bending unit.

FIG. 3 is a perspective view showing the feed sensors and the paper transfer unit.

### EXPLANATION OF PART REFERENCES

A. Cornet bending machine
1. Feeding magazine
2. Transmission apparatus
3. Feeding apparatus engines
4. Sliding equipment
5. Transfer line
6. Chopping knife
7. Knife sliding device
8. Tip bending unit
   8.1. Upper bending conical mold
   8.2. Lower bending conical mold
   8.3. Upper bending drive motor
   8.4. Lower bending drive motor
   8.5. On/Off engine
9. Tip bending engines
10. Glue tank
11. Glue injectors
12. Semilunar reel
13. Main body
14. Feeding sensors
15. Paper transfer unit
   15.1. Carrier feet
16. Chip suction unit

### DETAILED DESCRIPTION OF THE INVENTION

The invention relates to a high-speed cornet bending machine (A) with high production capacity and mechanically independent motion control system.

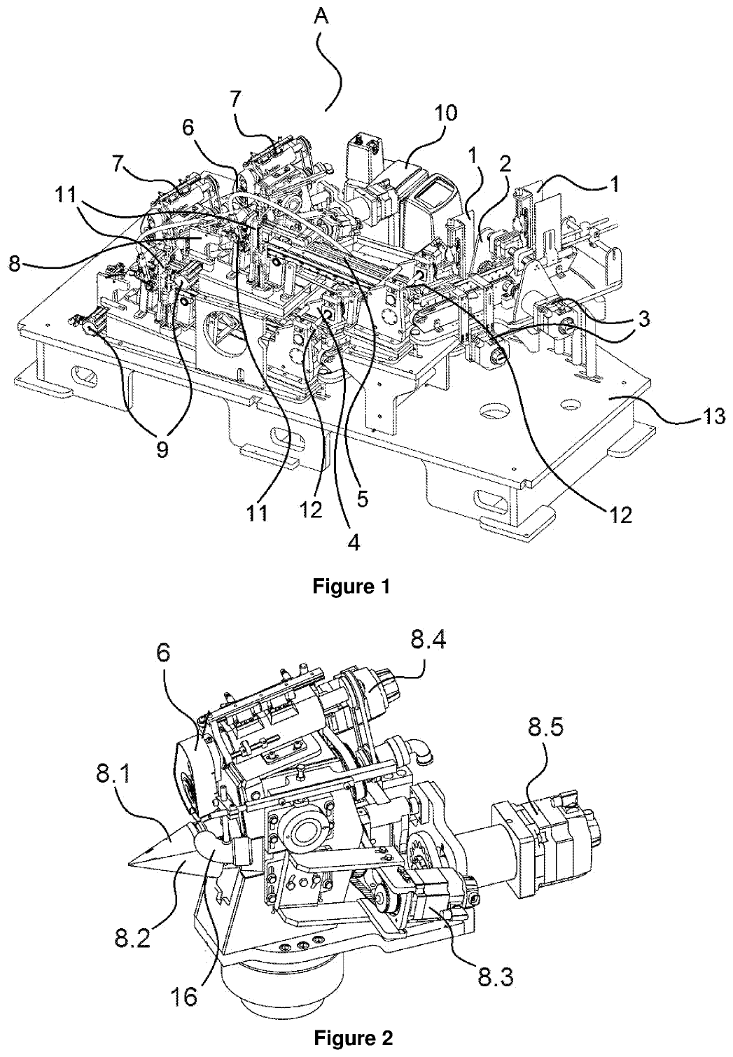

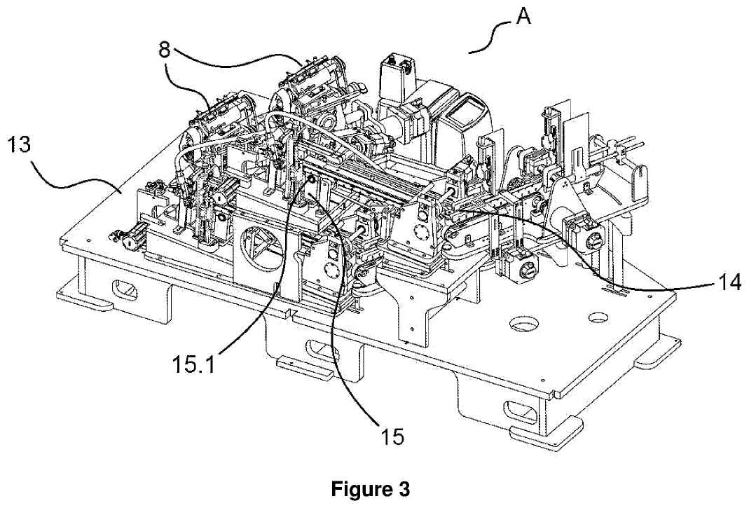

As shown in FIG. 1, the bending machine (A) according to the invention comprises a main body (13) which carries the elements forming the bending machine (A). On the main body (13), there is at least one feeding magazine (1) which sequentially transfers the papers to the conveying apparatus (2). The driving movement of said feeding magazine (1) is provided by the feeder motors (3). In front of the feeding magazine (1), the conveying belt (2) which is conveyed from the feeding apparatus (1) to the transfer line (5) is positioned. Said transfer line (5) transfers the papers from the transport apparatus (2) to the end bending unit (8) as standard. The sliding device 4 transfers the papers from the feeding magazine 1 to the transport apparatuses 2.

As seen in FIG. 1, the cornet bending machine A according to the invention comprises at least one saw blade 6 which cuts off the excess pieces on the paper going from the transfer line 5 to the end curling unit 8. When the cornet bending machine (A) stops next to the saw blade (6), the operator cuts the saw blade (6) from the end bending unit (8) at least one blade swivel (7) for preventing accidents is located.

As shown in FIG. 1, the cornet bender (A) according to the invention comprises a tip crimp unit (8) which allows the product ends to be crimped in a standard manner. On the sides of the end bending unit (8) are end bending motors (9) which allow the end bending unit (8) of the paper to enter smoothly.

As shown in FIG. 2, said end bending unit 8 is provided with an upper bending conical mold 8.1 for providing vacuum removal of the sheets from the transfer line 5 and an upper bending bushing mold 8 located under the upper bending conical mold 8.1, (8.2) which folds the paper together with the upper bending conical mold (8.1). The upper bending conical mold (8.1) gives the drive action the upper bending drive motor (8.3). The lower bending conical mold (8.2) gives the drive motion to the lower bending drive motor (8.4). Behind the upper curving conical mold (8.1) is the opening and closing motor (8.5) which allows the upper curving conical mold (8.1) to open and close. Beneath the chip blade (6), a chip suction unit (16) is located which allows the excess chips cut by the chip knife (6) to be sucked and discharged from the medium.

As shown in FIG. 1, the cornet bending machine subject to intervention (A) comprises a glue tank (10) which provides adhesion of the molten glue product. The glue injectors (11) allow the glue coming from the glue tank (10) to be driven onto the paper. Semi lunar reels (12) allow the sheets coming from the feeding magazine (1) to be driven to the transfer line (5).

As shown in FIG. 1, the cornet bender A according to the invention includes feed sensors 14 for starting the feed by sensing the position of the semi lunar reel 12 relative to the product and signaling the appropriate position. The paper transfer unit 15 located on the main body 13 transfers the paper from the transfer line 4 to the end bending unit by equally spacing the paper at a certain distance. The carrier feet (15.1) on the paper transfer unit (15) ensure that the papers are evenly spaced at a certain distance. The paper transfer unit (15) is positioned at an angle of at least 1 degree relative to the floor. In this way, the climbing motion is given to the products and the product transfer is carried out at higher speeds by preventing the undesired movement of the positioned products.

In accordance with the above information, the coating machine (A) according to the present invention operates in the following manner.

As shown in FIG. 1, the loading operation is carried out by the operator to the conveying apparatus 2 in such a manner that the cornet papers in the semi-finished state of the feed magazine 1 are overlaid. The products from the conveying apparatus 2 are removed one by one and conveyed in the fastest manner to the feed sensors 14 by means of the conveyor apparatus 4 on the feeding magazine 1 and held until the appropriate time information from the feed sensor 14 is received. When appropriate information is received, the product is transferred to the feed sensor (14). The semi lunar reel (12) on the transfer line (5) specified as the appropriate time information is the position relative to the product. Products are transferred to the paper transfer unit (15) by the semi lunar reel (12). The carrier feet (15.1) on the paper transfer unit (15) start conveying the products at a certain distance to the end bending unit (8) by aligning the end bending unit (8) During this transfer process, the products are positioned relative to the transfer line (5) with the upper curling conical mold (8.1) and the lower curling conical mold (8.2).

Gluing is carried out with the glue injector (11) in the interior of the products with the desired properties immediately before entering the end bending unit (8) in the products positioned and located in the vicinity of the end bending unit (8). Then the products coming in front of the end bending unit 8 are vacuumed by the upper bending conical mold 8.1 and the products received on the paper transfer unit 15 are compressed with the lower bending conical die 8.2 and bended at the same time by bending. During this bending operation, the upper overrunning drive motor (8.3) is provided. The lower bending conical mold (8.2) gives the drive motion to the lower bending drive motor (8.4). During this bending process, the excess chips formed in the mouth portion of the product are cut with the saw blade (6) rotating on the upper bending conical mold (8.1). Cut chips are sucked out by the chip suction unit (16). After the bending process and the chip cutting process are completed, the lower bending conical mold (8.2) is opened by the opening/closing motor (8.5) and the upper bending conical mold (8.1) In this way the production cycle is repeated continuously. The products are collected manually by the operator in the collection chamber.

In the cornet bending machine (A) of the invention, there are preferably two end bending units (8). In this way, the production speed is increased. The end bending units (8) on the cornet bending machine (A) operate independently of each other. In an alternative embodiment of the invention, the cornet bending machine (A) may have one or more multi-end bending units (8).

1. A high speed cornet bending machine with high production capacity and mechanically independent motion control system, characterized by:
at least one feeding magazine, which sequentially transfers the papers to a conveying apparatus;
feeder motors which give the drive action to the feeder magazine;
wherein the conveying apparatus feeds the sheets coming from the feeding magazine to a transfer line;
wherein the transfer line transfers the papers from the transport apparatus to an end bending unit as a standard; and
the end bending unit is provided to allow the product ends to be bent in a standard manner.

2. A coating machine according to claim 1, characterized by:
an upper bending conical mold which provides for the vacuum removal of the papers from the transfer line.

3. A coating machine according to claim 1, characterized by:
a lower bending conical mold which bend together with the upper bending conical mold by compressing the paper coming from the transfer line.

4. A coating machine according to claim 1,
wherein the upper bending conical mold comprises an upper bending drive motor providing the drive action.

5. A coating machine according to claim 1, wherein the lower bending conical mold comprises a lower bending drive motor providing the drive action.

6. A coating machine according to claim 1, characterized by:
an On/Off engine which allows the upper bending conical mold to be opened and closed.

7. A coating machine according to claim 1, comprising end bending motors which allow the paper to smoothly enter the end bending units of the paper.

8. A coating machine according to claim 1, comprising at least one saw blade which cuts off excess pieces on the paper going from the transfer line to the end bending unit.

9. A coating machine according to claim 1, wherein when the cornet bending machine stops, remove the saw blade from the end bending unit at least one blade slip device is provided for preventing accidents.

10. A coating machine according to claim 1, wherein the half-month spool includes feed sensors that sense the position relative to the product and initiate feeding by signaling the appropriate position.
